(19) United States
(12) Patent Application Publication
(10) Pub. No.: US 2025/0385411 A1
(43) Pub. Date: Dec. 18, 2025

(54) BATTERY WITH COVERED PLUG

(71) Applicant: Apple Inc., Cupertino, CA (US)

(72) Inventors: Daeshin Lee, San Jose, CA (US); Ee Min Lim, Singapore (SG); Joshua M. Chien, Portola Valley, CA (US); Rajesh Kandibanda, Menlo Park, CA (US); Liubin Zhou, Shenzhen (CN); He Li, Huizhou (CN)

(73) Assignee: Apple Inc., Cupertino, CA (US)

(21) Appl. No.: 18/745,945

(22) Filed: Jun. 17, 2024

(51) Int. Cl. H01M 50/645; H01M 50/103; H01M 50/15

(52) U.S. Cl. CPC H01M 50/645; H01M 50/103; H01M 50/15

(57) ABSTRACT

A battery that includes a housing defining a housing aperture, a battery cell stack positioned in the housing, a plug coupled to the housing over the housing aperture, a covering material disposed on at least a portion of the plug. The plug includes a first plate coupled to the housing and defining a first aperture, a second plate, and a lamination layer coupling the first plate to the second plate and defining a second aperture. The first aperture and the second aperture are aligned with the housing aperture.

### BACKGROUND

Batteries are used to provide electrical power to numerous devices, including tools, vehicles, laptop and tablet computers, and mobile phones. An injection aperture may be formed in the battery housing to allow for electrolyte to be injected in the housing and for effluent material and/or gases to escape if the battery overheats. Battery designs including these injection apertures may be improved.

### BRIEF SUMMARY

One aspect of the disclosure provides for a battery that includes a housing defining a housing aperture, a battery cell stack positioned in the housing, a plug coupled to the housing over the housing aperture, a covering material disposed on at least a portion of the plug. The plug includes a first plate coupled to the housing and defining a first aperture, a second plate, and a lamination layer coupling the first plate to the second plate and defining a second aperture. The first aperture and the second aperture are aligned with the housing aperture.

Implementations of this aspect may include one or more of the following features. The plug is coupled to the housing at a coupling point between the first layer and the housing and the covering material is disposed over the coupling point. The lamination layer, the second plate, and the housing are free of the covering material. The first layer is welded to the housing and the coupling point includes a welding location. The covering material is disposed over the first plate, the second plate, and the lamination layer. The covering material is disposed over the plug to contact the housing. The covering material is disposed over substantially an entirety of the first plate, the second plate, and the lamination layer. A central portion of a surface of the second plate is free of covering material. The covering material is disposed over the first plate and the lamination layer while the second plate is free of the covering material. The housing is free of the covering material. The covering material is configured to release from the plug at a temperature of 100° C. The covering material includes an ultraviolet adhesive. The covering material includes an adhesive tape.

Another aspect of the disclosure provides for a battery that includes a cover, a base coupled to the cover and defining an interior volume, where the base defines a housing aperture, a battery cell stack positioned in the interior volume, a plug coupled to the base over the housing aperture, and a covering material disposed on at least a portion of the plug. The plug includes a first plate coupled to the housing and defining a first aperture, a second plate, and a lamination layer coupling the first plate to the second plate and defining a second aperture. The first aperture and the second aperture are aligned with the housing aperture.

Implementations of this aspect may include one or more of the following features. The plug is welded to the housing at a welding location between the first layer and the housing; and the covering material is disposed over the welding location. The lamination layer, the second plate, and the housing are free of the covering material. The covering material is disposed over the first plate, the second plate, and the lamination layer. The covering material is disposed over substantially an entirety of the first plate, the second plate, and the lamination layer. The covering material includes an ultraviolet adhesive.

Yet another aspect of the disclosure provides for a method of forming a battery that includes coupling a plug over a housing aperture defined by a housing having a battery cell stack and coupling a covering material over at least a portion of the plug. The plug includes a first plate coupled to the housing and defining a first aperture, a second plate, and a lamination layer coupling the first plate to the second plate and defining a second aperture. The first aperture and the second aperture are aligned with the housing aperture.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A depicts a top isometric view of a prior art battery.

FIG. 1B depicts a bottom isometric view of the prior art battery of FIG. 1A.

FIG. 1C depicts a cross-sectional view of the prior art battery of FIG. 1A across Section A-A.

FIG. 2A depicts a cross-sectional view of a battery according to an embodiment of the disclosure.

FIG. 2B depicts a cross-sectional view of the battery of FIG. 2A across Section B-B.

FIG. 3 depicts a cross-sectional view of a battery according to an embodiment of the disclosure.

FIG. 4 depicts a cross-sectional view of a battery according to an embodiment of the disclosure.

FIG. 5 depicts a cross-sectional view of a battery according to an embodiment of the disclosure.

FIG. 6 depicts a cross-sectional view of a battery according to an embodiment of the disclosure.

FIG. 7 depicts a cross-sectional view of a battery according to an embodiment of the disclosure.

FIG. 8 depicts a cross-sectional view of a battery according to an embodiment of the disclosure.

FIG. 9 depicts a flowchart for forming a battery according to an embodiment of the disclosure.

### DETAILED DESCRIPTION

An injection aperture may be formed in a housing of a battery to allow for electrolyte to be injected into the housing as well as to allow for effluent material and/or gas to escape from the housing if the battery overheats and experiences a thermal runaway event. A plug may be welded over the injection aperture after electrolyte is injected into the housing to seal the electrolyte in the housing. For example, during normal operating conditions of the battery (e.g., at temperatures stably held below about 130° C., below about 110° C., below about 90° C., or the like), the plug may prevent moisture ingress into the battery housing and prevent electrolyte escaping out of the battery housing when the battery is at normal operating conditions.

The plug may be designed in a manner such that certain portions of the plug may fail when the battery experiences thermal runaway events to allow the egress of built-up effluent material and gases from inside the battery housing. The battery may experience a thermal runaway event when the temperature of the battery exceeds the temperatures of the battery normal operating conditions (e.g., the battery has a temperature greater than about 90° C., greater than about 110° C., greater than about 130° C., or the like) for a certain period of time (e.g., 5 seconds, 10 seconds, 1 minute, or the like). For example, at temperatures greater than about 90° C., the battery cell stack may start to deteriorate and gas may start to form due to the electrolyte decomposition. This function of the plug is important to prevent the effluent material and gases from building up inside the battery housing so much that the battery damages the surrounding environment (e.g., starting a fire, exploding, or the like). As will be described further below, the plug may include multiple layers that, under normal operating conditions, may be coupled together and, when the battery is undergoing a thermal runaway event, may fail by decoupling from each other such that the plug exposes the injection aperture of the housing. In this manner, the plug may be designed to fail at certain temperatures to minimize the risk that the battery damages the surrounding environment during a thermal runaway event.

However, in some examples, the plug may prematurely fail at certain temperatures and humidities prior to a thermal runaway event. For example, the plug may include defects that are difficult to detect, such as plug deformation (e.g., cracking, scratching, bending, or the like) or improperly coupling (e.g., improper lamination, adhesive, or the like) of the plug layers. These defects may lead to the layers of the plug decoupling from each other during normal operating conditions (e.g., at temperatures cooler than those experienced by the battery in a thermal runaway event). Additionally, the plug may prematurely fail at the coupling points between the plug and the battery housing, such as at the weld locations between the plug and the battery housing. For example, the plug may crack or burst at the weld locations between the plug under normal operating conditions. These premature failures of the plug may lead the injection aperture to be exposed while the battery is at normal operating conditions. This can, in turn, lead to the failure of the battery due to electrolyte leaking out of the battery injection aperture, moisture entering into the injection aperture, or the like.

The present disclosure addresses these issues by providing a battery with a covering material disposed on the plug. For example, the covering material may be an adhesive (e.g., an ultraviolet (UV) adhesive) disposed on the plug. The covering material may cover various portions of the plug, including the entirety of the plug, only at the coupling points between the plug and the housing, or other configurations of the covering material covering certain portions of the plug. The covering material may mitigate potential manufacturing defects of the plug, and strengthen the coupling points between the plug and the housing. In particular, where the plug may have deformation, the covering material my fill in the cracks. Where the layers of the plug may be improperly coupled, the covering material may strengthen the coupling between the layers. Additionally, the covering material may be disposed on the coupling points to mitigate premature failure at those coupling points. At the same time, the covering material may be configured to decouple from the plug at certain high temperatures (e.g., temperatures when the battery undergoes a thermal runaway event) while remaining coupled to the plug at cooler temperatures. Accordingly, the covering material may be beneficial to further strengthen the plug, as well as the coupling between the plug and the battery housing, at normal operating conditions while also allowing for the plug to decouple from the battery housing so that the battery may expel effluent material/gases during thermal runaway events.

The various designs and methods disclosed herein provide for battery cans for any type of electrical device. It will be appreciated that, although some of the example implementations described herein involve the battery providing power to a type of electrical device, such as a cell phone, tablet computer, wearable device, or laptop computer, the battery designs and methods described herein may apply to any type of electrical device, computing system or mobile device where power from a battery may be desired to power the device. The battery cans and enclosures can be used for any battery configuration (e.g., a battery cell stack) known in the art. As used herein, the term “battery cell stack” may include, but is not limited to, a stacked-electrode or wound jelly roll configuration. Further, any type of lithium-ion cell may be used with the embodiments and designs of the battery can described herein.

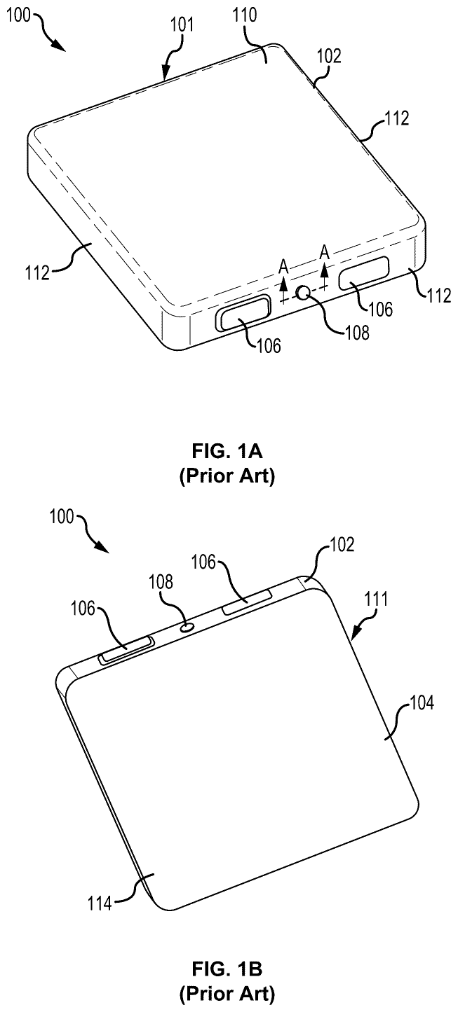

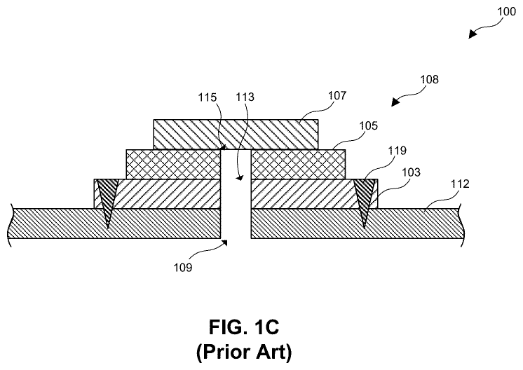

FIGS. 1A-1C depict a prior art battery 100. In particular, the battery 100 includes a housing 111 that may define an interior volume including a battery cell stack. The housing 111 may have a first portion, or upper portion 102, that has an optionally flat or semi-flat surface 110 and four walls 112 that extend from the flat or semi-flat surface. The first portion may be a base of the housing 111. In general, the dimensions (e.g., width and length) of the flat or semi-flat surface 110 are larger than the dimensions of the walls 112 such that the four walls are smaller in area than the larger flat or semi-flat surface 110 to form a rectangular shape with an opening along one of the larger surfaces of the rectangle. The regions of the first portion 102 where the surface 110 meets the four walls 112 may form an edge. In some embodiments the edge can have a right angle or may be rounded. Similarly, the regions of the first portion 102 where the four walls 112 meet may form a corner; in some embodiments the corner may be a right angle, an obtuse angle, an acute angle or may be rounded. In addition, one or more electrical contacts 106 may be located on a wall 112 of the first portion 102. The electrical contacts 106 provide electrical connections to a battery stack contained within the battery 100.

The housing 111 may also include a second portion 104. The second portion 104 may be a cover of the housing 111. In one embodiment, the second portion 104 includes a similar shape as the first portion 102, namely, a flat or semi-flat surface 114. In the embodiment, the length and width of the flat or semi-flat surface 114 may include slightly smaller dimensions than corresponding dimensions of the flat or semi-flat surface 110 of the first portion 102. Thus, when mated, the walls of the second portion 104 may be coupled to the walls 112 of the first portion 102 to form a box-like enclosure. In another embodiment, the second portion 104 includes the flat or semi-flat surface 114. In general, the dimensions of the flat or semi-flat surface 114 of the second portion 104, in this embodiment, are the same or similar to the flat or semi-flat surface 110 of the first portion 102 such that, when mated, the first and second portion of the battery form a box-like enclosure for housing a battery stack. In other embodiments, the housing may have other shapes, such as having multiple portions that have different dimensions (e.g., forming the housing to have an L-shape or the like).

The battery 100 may include a plug 108 covering an injection aperture 109 (e.g., a housing aperture), shown in FIG. 1C, defined on one of the walls 112. Although the injection aperture 109 and plug 108 are depicted on a same wall 112 as the electrical contacts 106, in other embodiments, the injection aperture and the plug may be positioned on any of the other walls. FIG. 1C depicts a cross-sectional schematic view of the battery 100 along Section A-A. The injection aperture 109 may be sized and shaped to receive electrolyte within the housing 111. Additionally, the injection aperture 109 may be sized and shaped to allow effluent material and/or gases to escape the housing 111 if the battery 100 undergoes a thermal runaway event. In other embodiments, the housing may define multiple injection apertures and multiple plugs coupled to the housing that can each cover one or more of those injection apertures.

The plug 108 may be coupled to the wall 112 over the injection aperture 109 to fluidly isolate an interior volume of the housing 111 from the external environment (e.g., to prevent moisture ingress into the interior volume of the housing 111) at a normal operating condition. Additionally, as will be discussed below, the plug 108 may fail when the temperature of the battery 100 exceeds that normal operating condition (e.g., a thermal runaway event) such that certain portions of the plug 108 may decouple from each other.

The plug 108 may include a first layer 103, a second layer 105, and a third layer 107. The first layer 103 may define a first aperture 113 and the second layer 105 may define a second aperture 115. The injection aperture 109, the first aperture 113, and the third aperture 115 may be aligned with each other. For example, the apertures 109, 113, 115 may be concentric with each other. In this manner, if the battery 100 undergoes a thermal runaway event, and the plug 108 fails such that one or more of the layers 103, 105, 107 decouple from each other, effluent material and/or gases from the interior volume of the housing 111 may escape outside of the housing 111 through the apertures 109, 113, 115. Failure of the plug 108 may include the first layer 103 decoupling from the second layer 105, the second layer 105 decoupling from the 107, or each of the layers 103, 105, 107 decoupling from each other.

The second layer 105 may be positioned between the first layer 103 and the third layer 107 such that the first layer 103 and the third layer 107 may be coupled together through the second layer 105. For example, the second layer 105 may have an adhesive quality such that the second layer 105 adheres, bonds, or otherwise couples the first layer 103 to the third layer 107. As the second layer 105 may couple the first layer 103 to the third layer 107, the second layer 105 may be described as a lamination layer. The first layer 103 and the third layer 107 may each be a plate that includes a metal material. For example, the layers 103, 107 may include nickel, steel, tin, aluminum, or the like. The second layer 105 may include a plastic material. For example, the second layer 105 may be polypropylene or the like.

The second layer 105 may lose all or a part of its adhesive quality when the second layer 105 reaches a certain temperature. For example, when the battery 100 undergoes a thermal runaway event, the second layer 105 may melt such that the first layer 103 and the third layer 107 at least partially decouple (e.g., delaminates or otherwise separates) from each other.

The plug 108 may be coupled to the wall 112 through welding, soldering, brazing, adhesive, or the like. For example, the plug 108 may be welded to the wall 112 through coupling points 119 (e.g., welding locations). In particular, the coupling points 119 may weld the first layer 103 to the wall 112. Although only two coupling points 119 are depicted, in other embodiments, the plug may be welded to the wall with any number of coupling points and along any portion of the first layer. In some embodiments, there may be a single coupling point 119 that at least partially or entirely encircles the second layer 105 around the first layer 103.

As discussed above, due to manufacturing defects or coupling issues between the plug 108 and the wall 112, the plug 108 may decouple from the housing 111 to the battery 100 under normal operating conditions (e.g., before experiencing a thermal runaway event). The battery of the present disclosure addresses this issue by providing a covering material over the plug to mitigate those manufacturing defects and coupling issues.

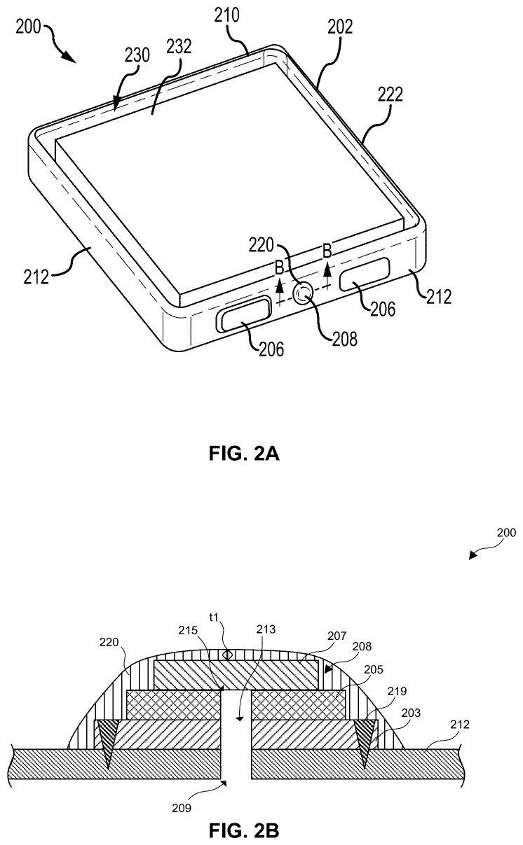

For example, FIGS. 2A and 2B depict a battery 200 including a covering material 220. It is understood that features ending in like reference numerals as features discussed above are similar, except as noted below. Turning to FIG. 2A, an upper surface of the battery 200 (e.g., surface 110, as shown in FIG. 1A) is omitted to better depict an interior volume 330 housing a battery cell stack 232 (shown schematically).

The covering material 220 may be disposed over the injection plug 208. For example, turning to FIG. 2B, depicting a cross-sectional schematic view of the battery 200 along Section B-B. The covering material 220 may cover substantially the entirety of the plug 208 and also contact the wall 212. For example, the covering material 220 may cover greater than about 80% of the plug 208, greater than about 85%, greater than about 90%, greater than about 95%, or completely cover the plug 208. In this manner, the covering material 220 may provide complete coverage over the plug 208. As will be described below, the covering material 220 may be provided to provide a sealing and adhesive characteristics under normal operating conditions while allowing for the plug 208 to open up, as described above, when the battery 200 experiences a thermal runaway event.

The covering material 220 may include an adhesive quality to strengthen the coupling between the layers 203, 205, 207 as well as to strengthen the coupling between the plug 208 and the wall 212 under normal operating conditions. For example, the covering material 220 may strengthen the coupling strength between the layers 203, 205, 207 and minimize the risk that the layers 203, 205, 207 decouple from each other due to manufacturing defects (e.g., deformation, improper coupling of the layers 203, 205, 207, or the like). Additionally, the covering material 220 may decrease the risk that the first layer 203 decouples from the wall 212 (e.g., cracking and bursting where the coupling points 219 are welding locations) under normal operating conditions.

The covering material 220 may provide a seal over the plug 208 such that the covering material 220 provides insulative qualities to the plug 208 under normal operating conditions. For example, the covering material 220 may prevent moisture ingress into an interior volume of the battery 100. This may be especially beneficial where the plug 208 includes deformations that would otherwise allow moisture ingress into the battery 200. The covering material 220 may provide this sealing quality at a temperature of less than about 130° C., less than about 110° C., less than about 90° C. For example, the covering material 220 may provide this sealing quality at a temperature of between about 40° C. and 100° C., such as between about 50° C. and 90° C., such as between about 60° C. and 80° C., or about 70° C.

The covering material 220 may lose its adhesive quality once a certain temperature is reached. For example, the covering material 220 may at least partially decouple (e.g., melt, evaporate, or the like) from the plug 208 and the wall 212 once the battery 200 undergoes a thermal runaway event (e.g., once the covering material 220 is exposed a temperature greater than about 90° C., greater than about 110° C., greater than about 130° C., or the like). For example, the covering material 220 may include a lap-shear strength of less than 0.2 MPa, less than about 0.15 MPa, less than about 0.1 MPa, or less than about 0.05 MPa. In this manner, the covering material 220 may provide adhesive and sealing qualities to the plug 208 and the wall 212 while also allowing the plug 208 to open, as described above, to allow for effluent material and/or gas to escape out of the battery 200 during a thermal runaway event. In some embodiments, where the covering material 220 melts from the plug 208 and the wall 212, the covering material 220 may regain its adhesive and sealing qualities once the covering material 220 cools down to a temperature cooler than a thermal runaway event. However, in other embodiments, the covering material may not recover its initial adhesive and sealing qualities and, instead, by permanently decoupling from the plug and/or housing.

In some embodiments, the covering material 220 may lose its adhesive quality at a temperature that is just lower than the temperature of a thermal runaway event. In this manner, the covering material 220 may at least partially decouple from the plug 208 and the wall 212 prior to a thermal runaway event so that the plug 208 may open without the risk that the covering material 220 interferes (e.g., without the risk that the covering material 220 at least partially maintains its adhesive qualities between the layers 203, 205, 207 during a thermal runaway event). In this example, the covering material 220 may decouple from the plug 208 sufficiently to allow the plug 208 to open at a temperature between about 80° C. and 110° C., between about 85° C. and 105°, or between about 90° and 100° C.

The covering material 220 may include a material that is capable of providing the sealing and adhesive qualities noted above, while also being able to decouple from the plug 208 once the covering material 220 is exposed to certain temperatures just prior to, or at, the battery 100 undergoing a thermal runaway event. For example, the covering material 220 may include an adhesive, such as an epoxy adhesive, polyurethane adhesive, a polyimide adhesive, acrylic adhesive (e.g., acrylic styrene acrylate), benzoyl-based adhesive, or the like. The adhesive may be a hot melt adhesive, reactive hot melt adhesive, pressure sensitive adhesive, contact adhesive, or the like. The covering material 220 may be a paste, liquid, film, solid, or the like. In one example, the covering material 220 may include an ultraviolet adhesive (e.g., UV curing polyurethane adhesive). In other embodiments, the covering material 220 may be a tape, such as an ultraviolet glue tape. One particular example adhesive may include one or more of: acryl nitrile styrene polymero-(p-isocyanatobenzyl)phenyl isocyanate; glycerol, propoxylated; diphenylmethanediisocyanate, isomeres and homologues; 4,4′-methylenediphenyl diisocyanate; 4,4-methylenediphenyl diisocyanate, oligomers; and 4-isocyanatosulphonyltoluene. Another example adhesive may include one or more of: polyurethane acrylate; functional monomer; isobornyl acrylate; diphenyl(2,4,6-trimethylbenzoyl)phosphine oxide; and silica. Yet another example adhesive may include: 1-Benzoylcyclohexanol; glycerol, propoxylated; ethylene bis(3-mercaptopropionate); diphenylmethanediisocyanate, isomeres and homologues; 4,4′-methylenediphenyl diisocyanate; 4,4-methylenediphenyl diisocyanate, oligomers; o-(p-isocyanatobenzyl)phenyl isocyanate; and 4-isocyanatosulphonyltoluene.

The covering material 220 may be applied over the plug 208 just enough to provide the sealing and adhesive qualities as described above. However, it may be beneficial to minimize how far the covering material 220 extends past the plug 208 to decrease an overall size of the battery 200. For example, the covering material 220 may include a thickness t1 past the third layer 207 of between about 0.1 mm and 1.2 mm, such as between about 0.2 mm and 1 mm, such as between about 0.4 mm and 0.8 mm, or such as about 0.6 mm.

The configuration of the covering material 220 disposed over the plug 208 and the wall 212 may provide an additional benefit of being easy to apply over the plug 208 and the wall 212. For example, where the covering material 220 includes a liquid adhesive, the covering material 220 may be applied with only sufficient precision to cover the plug 208 and portions of the wall 212 surrounding the plug 208. However, in other embodiments, the covering material may be more selectively applied to save on material costs.

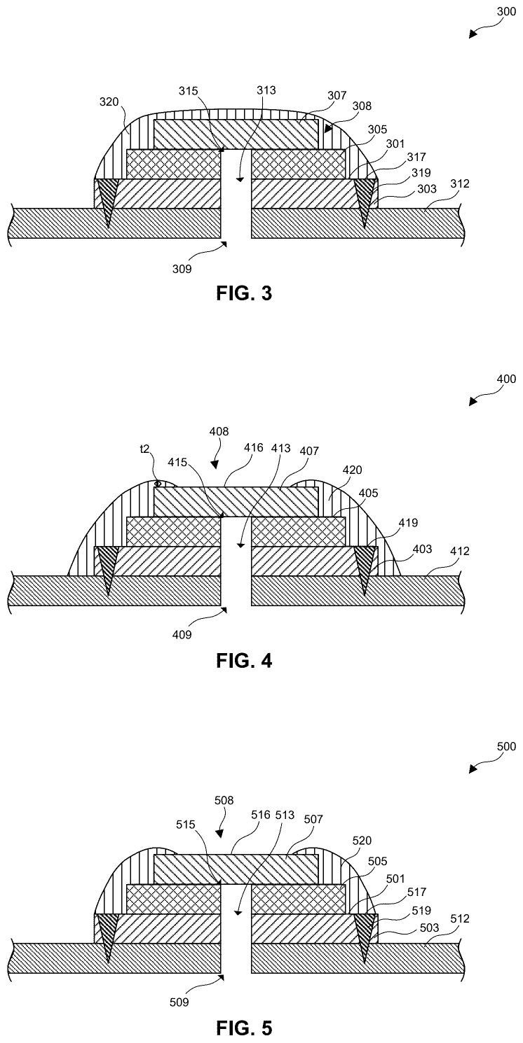

For example, FIG. 3 depicts a battery 300 including a covering material 320. It is understood that features ending in like reference numerals as features discussed above are similar, except as noted below. In some embodiments, the plug 308 may be more likely to decouple from the wall 312 along a first layer surface 301 of the first layer 303 and coupling surfaces 317 of the coupling points 319 than at other points between the first layer 303 and the wall 312. As such, the covering material 320 may be disposed over the plug 308 such that the covering material 320 overlays the layers 303, 305, 307 to completely cover the second layer 305 and the third layer 307 without contacting the wall 312. In this manner, the covering material 320 may strengthen the coupling between the layers 303, 305, 307 to minimize the risk of the plug 308 failing due to manufacturing defects, as discussed above, and improving the coupling strength between the first layer 303 and the wall 312 at the coupling points 319 along the first layer surface 301 and the coupling surfaces 317 while also minimizing material costs.

FIG. 4 depicts a battery 400 including a covering material 420. It is understood that features ending in like reference numerals as features discussed above are similar, except as noted below. The covering material 420 may be disposed over the plug 408 to contact the wall 412 while leaving a central portion of a third layer surface 416 exposed (e.g., free of the covering material 420). The covering material 420 may leave between about 5% and 95% of the third layer surface 416 exposed, between about 15% and 85%, between about 25% and 75%, between about 35% and 65%, between about 45% and 55%, or about 50%. As entirely covering the third layer surface 416 may not necessarily provide adhesive or sealing benefits between the layers 403, 405, 407, and between the plug 408 and the wall 412, the configuration of the covering material 420 on the plug 408 may be beneficial to save on material costs.

Additionally, the covering material 420 may extend a thickness t2 past the third layer 407. As the covering material 420 may leave a portion of the third layer surface 416 exposed, the covering material may have a lesser height than other embodiments (e.g., as the covering material 220, 320, as shown in FIGS. 2A, 2B, and 3) while providing similar adhesive and sealing benefits to those embodiments (e.g., as the covering material 220, as shown in FIGS. 2A and 2B) by covering all of the layers 403, 405, 407 and contacting the wall 412. For example, with the covering material 420 at normal operating conditions, the force required to decouple one or more of the layers 403, 405, 407 from each other may be between about 10 N and 70 N, such as between about 20 N and 60 N, such as between about 30 N and 50 N, or about 40 N. This force may be larger than the force required to decouple the layers 403, 405, 407 without the covering material 420. The thickness t2 may be less than about 0.45 mm, such as less than about 0.4 mm, such as less than 0.35 mm, such as less than about 0.3 mm, such as less than about 0.25 mm, such as less than about 0.2 mm, or such as less than about 0.15 mm.

The covering material 420 may be a monolithic structure that circumferentially goes around the plug 408, however, in other embodiments, the covering material may be multiple structures applied over the plug and onto the wall. For example, the covering material may be applied in a dotted or patterned manner about the plug. In other embodiments, the covering material may not be symmetrically applied about the plug. For example, on one side of the plug, the covering material may be disposed over all the layers of the plug to contact the wall but, on the other side of the plug, the covering material be disposed over all the layers of the plug and not contact the wall.

FIG. 5 depicts a battery 500 including a covering material 520. It is understood that features ending in like reference numerals as features discussed above are similar, except as noted below. The covering material 520 may be disposed over the plug 508 such that the covering material 520 overlays the layers 503, 505, 507 while leaving a central portion of the third layer surface 516 exposed and without contacting the wall 512. The covering material 520 may leave between about 5% and 95% of the third layer surface 516 exposed, between about 15% and 85%, between about 25% and 75%, between about 35% and 65%, between about 45% and 55%, or about 50%. As entirely covering the third layer surface 516 may not provide adhesive or sealing benefits, the configuration of the covering material 520 on the plug 508 may be beneficial to save on material costs while also covering the first layer surface 501 of the first layer 503 and coupling surfaces 517 of the coupling points 519 to strengthen the coupling between the coupling points 519 and the first layer 503.

The covering material 520 may be a monolithic structure that circumferentially goes around the plug 508, however, in other embodiments, the covering material may be multiple structures applied over the plug and onto the wall. For example, the covering material may be applied in a dotted or patterned manner about the plug. In other embodiments, the covering material may not be symmetrically applied about the plug. For example, on one side of the plug, the covering material may be disposed over all the layers of the plug to contact the wall but, on the other side of the plug, the covering material be disposed over all the layers of the plug and not contact the wall.

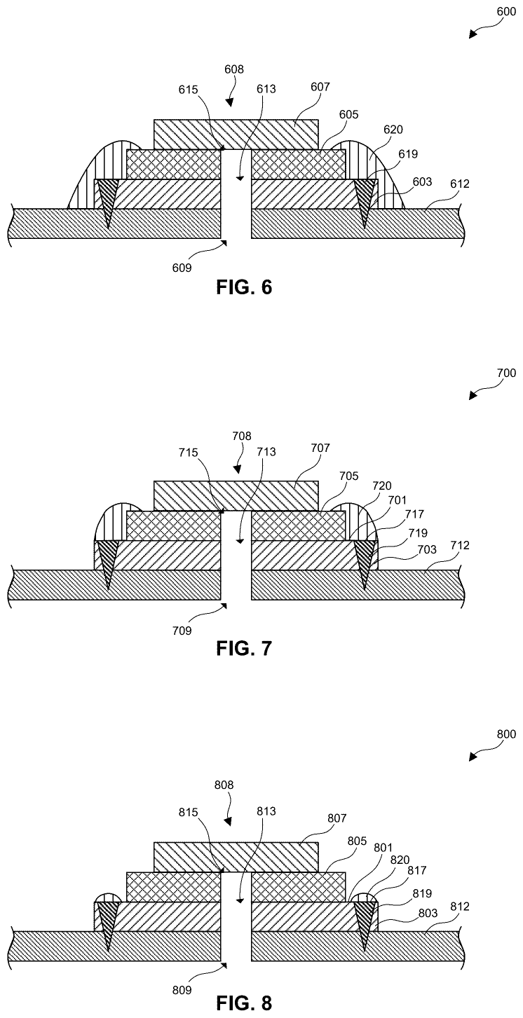

FIG. 6 depicts a battery 600 including a covering material 620. It is understood that features ending in like reference numerals as features discussed above are similar, except as noted below. In some embodiments, it may be less likely that the third layer 607 prematurely decouples from second layer 605 while the battery 600 is at normal operating conditions than between the first layer 603 and the second layer 605. As such, the covering material 620 may be disposed over the plug 608 such that the covering material 620 overlays the first layer 603 and the second layer 605 to contact the wall 612 while leaving the third layer 607 exposed. This may be beneficial to minimize material costs while providing adhesive and sealing qualities between the first layer 603, the second layer 605, and the wall 612. However, in other embodiments, the covering material may not leave the entirety of the third layer exposed and, instead, may only expose certain portions of the third layer. For example, in this example, the covering material may leave only a top surface of the third layer exposed while the covering material contacts a portion or entirety of the lateral sides of the third layer.

The covering material 620 may be a monolithic structure that circumferentially goes around the plug 608, however, in other embodiments, the covering material may be multiple structures applied over the plug and onto the wall. For example, the covering material may be applied in a dotted or patterned manner about the plug. In other embodiments, the covering material may not be symmetrically applied about the plug. For example, on one side of the plug, the covering material may be disposed over all the layers of the plug to contact the wall but, on the other side of the plug, the covering material be disposed over all the layers of the plug and not contact the wall.

FIG. 7 depicts a battery 700 including a covering material 720. It is understood that features ending in like reference numerals as features discussed above are similar, except as noted below. In some embodiments, it may be less likely that the third layer 707 prematurely decouples from second layer 705 while the battery 700 is at normal operating conditions than between the first layer 703 and the second layer 705. At the same time, it may be more likely that the plug 708 decouples from the wall 712 along a first layer surface 701 of the first layer 703 and coupling surfaces 717 of the coupling points 719 than at other points between the first layer 703 and the wall 712. As such, the covering material 720 may be disposed over the plug 708 such that the covering material 720 overlays the first layer 703 and the second layer 705 to contact the wall 712 while leaving the third layer 707 exposed and without contacting the wall 712. This may be beneficial to minimize material costs while providing the adhesive and sealing qualities between the first layer 703 and the second layer 705, and also covering the first layer surface 701 and coupling surfaces 717 of the coupling points 719 to strengthen the coupling between the coupling points 719 and the first layer 703.

The covering material 720 may be a monolithic structure that circumferentially goes around the plug 708, however, in other embodiments, the covering material may be multiple structures applied over the plug and onto the wall. For example, the covering material may be applied in a dotted or patterned manner about the plug. In other embodiments, the covering material may not be symmetrically applied about the plug. For example, on one side of the plug, the covering material may be disposed over all the layers of the plug to contact the wall but, on the other side of the plug, the covering material be disposed over all the layers of the plug and not contact the wall.

FIG. 8 depicts a battery 800 including a covering material 820. It is understood that features ending in like reference numerals as features discussed above are similar, except as noted below. In some embodiments, there may be a higher risk of the plug 808 decoupling from the wall 812 between the first layer surface 801 and the coupling surface 817 than at other points between the plug 808 and the wall 812. Additionally, this risk may be higher than a risk that the layers 803, 805, 807 of the plug 808 prematurely decouple from each other. As such, the covering material 820 may be disposed over the first layer surface 801 and the coupling surface 817 while leaving the rest of the plug 808 free of covering material 820 and without contacting the wall 812. This may save on material costs while focusing only on likely points of premature failure on the battery 800.

The covering material 820 may be a monolithic structure that circumferentially goes around the plug 808, however, in other embodiments, the covering material may be multiple structures applied over the plug and onto the wall. For example, the covering material may be applied in a dotted or patterned manner about the plug. In other embodiments, the covering material may not be symmetrically applied about the plug. For example, on one side of the plug, the covering material may be disposed over all the layers of the plug to contact the wall but, on the other side of the plug, the covering material be disposed over all the layers of the plug and not contact the wall.

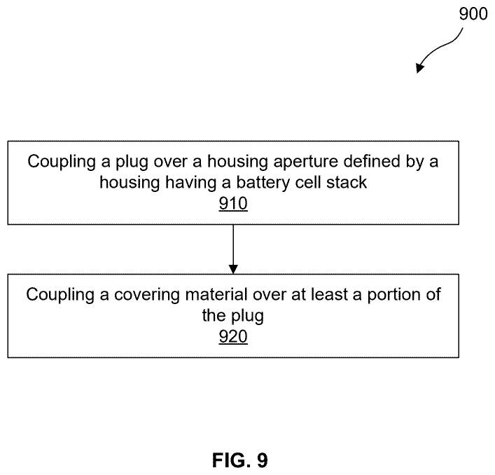

FIG. 9 depicts an example flowchart showing a process 900 for forming a battery. It is understood that features ending in like reference numerals as features discussed above are similar, except as noted below. Unless step specified otherwise, the flowchart in FIG. 9 will be described with reference to the battery 200 shown in FIGS. 2A and 2B.

Block 910 may include coupling a plug over a housing aperture defined by a housing having a battery cell stack. For example, the plug 208 may be coupled to the wall 212 over the housing aperture 209. The plug 208 may be coupled to the wall 212 at the coupling points 219. In one example, the plug 208 may be welded to the wall 212 and the coupling points 219 may be weld locations between the first layer 203 and the wall 212.

Block 920 may include coupling a covering material over at least a portion of the plug. For example, the covering material 220 may be coupled over (e.g., deposited by a spray, injection apparatus, or other deposition apparatus) the plug 208. The covering material 220 may be disposed over an entirety of the plug 208 to contact the wall 212. However, in other embodiments, the covering material may be disposed over less than an entirety of the plug or may not contact the wall. For example, turning to FIG. 3, the coupling material 320 may be disposed over the plug 308 without contacting the wall 312. Turning to FIG. 4, the coupling material 420 may be disposed over the plug 408 to contact the wall 412 while leaving a portion of the third layer surface 416 exposed. Turning to FIG. 5, the coupling material 520 may be disposed over the plug 508 while leaving a portion of the third layer surface 516 exposed and without contacting the wall 512. Turning to FIG. 6, the coupling material 620 may be disposed over the plug 608 to contact the wall 612 while leaving the third layer 607 exposed. Turning to FIG. 7, the coupling material 720 may be disposed over the plug 708 without contacting the wall 712 and while leaving the third layer 707 exposed. Turning to FIG. 8, the coupling material 820 may be disposed over the plug 808 such that the covering material 820 is disposed over the coupling points 819 without contacting the wall 812, and while leaving the second layer 805 and the third layer 807 exposed.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom” or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery comprising:
a housing defining a housing aperture;
a battery cell stack positioned in the housing;
a plug coupled to the housing over the housing aperture, wherein:
the plug includes a first plate coupled to the housing and defining a first aperture, a second plate, and a lamination layer coupling the first plate to the second plate and defining a second aperture; and
the first aperture and the second aperture are aligned with the housing aperture; and
a covering material disposed on at least a portion of the plug.

2. The battery of claim 1, wherein:
the plug is coupled to the housing at a coupling point between the first layer and the housing; and
the covering material is disposed over the coupling point.

3. The battery of claim 2, wherein the lamination layer, the second plate, and the housing are free of the covering material.

4. The battery of claim 2, wherein the first layer is welded to the housing and the coupling point includes a welding location.

5. The battery of claim 1, wherein the covering material is disposed over the first plate, the second plate, and the lamination layer.

6. The battery of claim 5, wherein the covering material is disposed over the plug to contact the housing.

7. The battery of claim 5, wherein the covering material is disposed over substantially an entirety of the first plate, the second plate, and the lamination layer.

8. The battery of claim 5, wherein a central portion of a surface of the second plate is free of covering material.

9. The battery of claim 1, wherein the covering material is disposed over the first plate and the lamination layer while the second plate is free of the covering material.

10. The battery of claim 9, wherein the housing is free of the covering material.

11. The battery of claim 1, wherein the covering material is configured to release from the plug at a temperature of 100° C.

12. The battery of claim 1, wherein the covering material includes an ultraviolet adhesive.

13. The battery of claim 1, wherein the covering material includes an adhesive tape.

14. A battery comprising:
a cover;
a base coupled to the cover and defining an interior volume, wherein the base defines a housing aperture;
a battery cell stack positioned in the interior volume;
a plug coupled to the base over the housing aperture, wherein:
the plug includes a first plate coupled to the housing and defining a first aperture, a second plate, and a lamination layer coupling the first plate to the second plate and defining a second aperture; and
the first aperture and the second aperture are aligned with the housing aperture; and
a covering material disposed on at least a portion of the plug.

15. The battery of claim 14, wherein:
the plug is welded to the housing at a welding location between the first layer and the housing; and
the covering material is disposed over the welding location.

16. The battery of claim 14, wherein the lamination layer, the second plate, and the housing are free of the covering material.

17. The battery of claim 14, wherein the covering material is disposed over the first plate, the second plate, and the lamination layer.

18. The battery of claim 17, wherein the covering material is disposed over substantially an entirety of the first plate, the second plate, and the lamination layer.

19. The battery of claim 14, wherein the covering material includes an ultraviolet adhesive.

20. A method of forming a battery comprising:
coupling a plug over a housing aperture defined by a housing having a battery cell stack, wherein:
the plug includes a first plate coupled to the housing and defining a first aperture, a second plate, and a lamination layer coupling the first plate to the second plate and defining a second aperture; and
the first aperture and the second aperture are aligned with the housing aperture; and
coupling a covering material over at least a portion of the plug.
